(19) United States
(12) Patent Application Publication
(10) Pub. No.: US 2009/0220909 A1
(43) Pub. Date: Sep. 3, 2009

(54) OCCLUSION DEVICE FOR BLOCKING AN APICAL OPENING OF A ROOT CANAL OF A TOOTH

(75) Inventors: Barbara Müller, Langenau (DE); Werner Mannschedel, Langenau (DE)

Correspondence Address: KATTEN MUCHIN ROSENMAN LLP, 575 MADISON AVENUE, NEW YORK, NY, 10022-2585, US

(73) Assignee: COLTENE/WHALEDENT GMBH & CO KG, LANGENAU (DE)

(21) Appl. No.: 12/091,208

(22) PCT Filed: Nov. 14, 2006
(86) PCT No.: PCT/EP06/10920

§ 371 Date: Jun. 18, 2008

(51) Int. Cl. A61C 5/02

(52) U.S. Cl. 433/81

(57) ABSTRACT

The invention relates to an obturation device (1) for blocking an apical foramen of a root canal of a tooth by means of an obturation plugging mass. The obturation device (1) has a carrier (5), wherein the obturation plugging mass is arranged in slidingly displaceable manner, and has an applicator (6), by means of which the obturation plug (4) comprising obturation plugging mass is applied in the apical foramen. The applicator (6) has a housing (7) with a pushing mechanism (8), which mechanism is arranged to be brought into engagement with the carrier (5) and pushes the obturation plugging mass from the carrier (5) into the apical foramen.

Root canal treatment requires sterile preparation devices for the root canal and, finally, blocking of the apical foramen of the root canal—in the course of which there is a danger of also introducing bacteria and/or toxins—in such a way that the risk of post-endodontic complications, such as apical osteolysis or acute periapical ostitis, is reduced to the utmost by means of the blocking.

The apical foramen is conventionally blocked with dentin particles. This prevents over-plugging of the root canal on subsequent filling with sealing material—also referred to as “sealer”—and with a filling material such as gutta-percha. However, when blocking with dentin particles there is a danger of bacteria being present between the dentin particles, which can cause a new infection.

An obturation system marketed under the name “Simplyfill” employs gutta-percha for blocking the apical foramen. For that purpose, the gutta-percha material is screw-mounted on a carrier which is longitudinally displaceable and which constitutes an auxiliary tool for the blocking. A disadvantage of that obturation system is that, after the gutta-percha material has been put in place, or applied, in the apical foramen, the carrier has to be unscrewed from the gutta-percha material. In the course thereof, disadvantageously, there is a risk of the gutta-percha material moving in the course of the carrier being un screwed, and reliable blocking of the apical foramen is jeopardised and penetration by bacteria cannot be reliably prevented.

A problem underlying the invention is to provide an obturation device which makes possible reliable application of an obturation material in the apical foramen and which overcomes the disadvantages of known obturation systems. A problem underlying the invention is, furthermore, to provide an applicator for the blocking, which can be used in multi-functional manner.

The problem is solved by the subject-matter of the independent claim 1. Advantageous developments of the invention result from the dependent claims.

In accordance with the invention, an obturation device is provided for the blocking of an apical foramen of a root canal of a tooth by means of an obturation plugging mass. For that purpose, the obturation device has a carrier, in which the obturation plugging mass is arranged in slidingly displaceable manner. The obturation device further has an applicator, by means of which the obturation plugging mass in the form of an obturation plug is applied in the apical foramen, the applicator having a housing with a pushing mechanism, which mechanism is arranged to be brought into engagement with the carrier, and the pushing mechanism pushing the obturation plugging mass from the carrier into the apical foramen.

An obturation device of such a kind has the advantage that it is based on the sliding displacement capability of a pushing mechanism, the obturation plug being pushed from a carrier into the apical foramen, so that a screwed connection is not required between the carrier and the gutta-percha plug. There is consequently no longer a risk of a torque being applied to the plug in the course of removing the carrier from the plug, or of loosening or twisting of the plug causing the reliability of blocking of the apical foramen to be jeopardised. Rather, with the aid of the pushing mechanism, a ram, which is extended out from the applicator in the direction of the obturation plugging mass of the carrier, can, in advantageous manner, be pulled back immediately after blocking of the apical foramen without the blocking being loaded with an applied force or loosened.

The applicator can be provided with many functions so that, for example, it has a variable stop function, a calibration function and/or a scale arrangement and measurement function, in order, for example, to reach predetermined tooth root depths with the carrier and the obturation plugging mass or obturation plug—hereinafter referred to as the obturation plug—in reliable and verifiable manner. Accordingly, for example, the depth of the root canal can be measured and/or the position of the obturation plug in the root canal determined.

Special preference is given to the obturation plugging mass being a prefabricated obturation plug which is solid at the processing temperature, preferably at room or body temperature. Without heating the obturation plug, which would alter the viscosity and/or hardness of the material of the obturation plug, for example gutta-percha, this obturation plug is introduced, by means of the obturation device according to the invention, directly into a prepared root canal. In corresponding manner, the obturation device does not have a heat source. Accordingly, there can advantageously be used an obturation plug which is matched to the dimensions of the root canal, for example with respect to the depth of the root canal or with respect to a particular shape that is prespecified as a result of the preparation. Because the obturation plug on introduction into a root canal, especially the apex of a root canal, is preferably not heated or is heated only insubstantially as a result of friction etc. on delivery from the obturation device, its shape does not change in the process. As a result, defined obturation of the root canal and/or apex can be achieved. Defined obturation of such a kind is not possible with obturation masses which are heated before or during delivery so that their shape changes on introduction into the root canal.

For rapid change-over of carriers with obturation plugs, push-in connections with a cone have been found to be suitable in a preferred embodiment of the invention. For that purpose, the carrier has, on a proximal end, a nozzle and, on a distal end, a connection projection in the form of a cone which can be push-mounted on a proximal end of the applicator. It is, in principle, also possible to provide a screwed or bayonet connection at that location between the proximal end of the applicator and the distal end of the carrier. The bayonet connection has the advantage that, by means of few actions, a releasable connection is established which is, however, more secure than a purely adherent connection by means of a cone at the connection projection of the carrier. The nozzle at the proximal end of the carrier is preferably matched to the size and shape of the particular obturation plug, the clear width of the nozzle especially corresponding to the external dimensions of the obturation plug.

Preferably, the obturation plug is arranged in the carrier. This has, on the one hand, the advantage that the obturation plug can be stored together with the carrier in secure and sterile manner and, on the other hand, the advantage that, after the carrier has been guided into the root canal with the aid of the pushing mechanism of the applicator, the obturation plug can be pushed out from the nozzle in guided manner in order to block the apical foramen.

The obturation plug material preferably comprises gutta-percha because in this case, as opposed to an obturation plug material of dentin particles, freedom from bacteria can be ensured. Besides pre-formed solid material, material in granulate form or pasty material can also be applied with the aid of the application device. This material could then cure or polymerise in a subsequent reaction at the apex. Highly pasty material would have the advantage that it adapts itself but does not flow out beyond the apex. The obturation plug material can further comprise customary additives such as, for example, an X-ray contrast medium in order to be able to determine the exact position of the obturation plug in the root canal. An obturation plug of gutta-percha material can especially have a point at its proximal end. The length l of the obturation plug depends on the size of the root canal and/or on the size of the apical foramen and is preferably in a range from 0.1 mm to 10 mm, preferably in the range from 1 mm to 5 mm. The obturation plug preferably has a cylindrical contour. This applies especially to obturation plugs having long lengths in the region of 10 mm.

Alternatively, the obturation plug can comprise a conical plug having a slope, as desired, from 4% to 10%. A conical slope of such a kind reflects the geometry of the root canal, which usually tapers conically towards the apical foramen. For use especially of gutta-percha points for blocking the apical foramen, cross-sections of an ISO standard are preferably used. A further preferred shape for the obturation plug has a step-shaped external contour. In that case, the steps are matched to the internal diameter of the nozzle at the proximal end of the carrier whilst the obturation plug point outside the carrier can have a shoulder the diameter of which is matched to the external diameter of the nozzle. This has the advantage that an optimal continuous transition is created from the gutta-percha point to the nozzle of the carrier so that the nozzle can be guided through the root canal to the apical foramen without injuring the root canal.

The following features relate mainly to the applicator and its various functions and also to merits and advantages of arrangements of the applicator.

In a first embodiment of the invention, the applicator has an elongate, tubular housing. Within the tubular housing there is guided a ram, which is actuatable from the outside and can be displaced in the longitudinal extent along the axis of symmetry of the elongate, tubular housing. Besides the ram of the pushing mechanism, a restoring element can be arranged in the housing. This restoring element ensures that, after pushing and pressing the gutta-percha plug into the apical foramen of the root canal, the ram is automatically pulled back resiliently. The ram therein can have a slidingly displaceable core and, at the proximal end of the slidingly displaceable core, an extension comprising a wire preferably of a nickel-titanium alloy or comprising a plastics stem. The cross-section of the extension therein is matched to the cross-section of the obturation plug.

In a further preferred embodiment of the invention, the restoring element of the pushing mechanism comprises a helical spring. This helical spring is arranged within a tubular region of the housing of the applicator and, at its proximal end, it abuts a constricted step in the housing. The distal end of the helical spring pushes against a slidingly displaceable core or rod of the pushing mechanism.

In a further embodiment of the invention, the restoring element comprises a bellows. This bellows is arranged at the distal end of the housing and terminates in a pressure plate against which, in the interior of the housing, the slidingly displaceable core or rod within the housing is arranged. Instead of a rod, it is also possible in this case for a core in the form of a wire or plastics stem, the cross-sections of which are matched to the cross-section of the obturation plug, already to be fixed to the pressure plate.

As a result of pressing on the pressure plate, the bellows is compressed and at the same time, in the interior of the housing, the slidingly displaceable element in the form of a rod, wire or plastics stem, is displaced in the direction of the proximal end of the applicator and, on removal of the load from the pressure plate, the bellows springs back and at the same time pulls the slidingly displaceable element fixed to it in the interior of the housing in the direction of the distal end of the applicator. The bellows arrangement is especially suitable for use once, the housing of the applicator undergoing an integral transition into the carrier, which at its proximal end opens out into a nozzle which can accommodate the obturation plug.

A further advantage of this embodiment of the invention is that the tubular housing can be formed of a flexible hose-like material in which a slidingly displaceable core or ram in the form of a wire or of a plastics stem is arranged.

Preference is given to the pushing mechanism of the applicator being in operative connection with an external measurement display, by means of which the depth of the root canal can be measured and/or the position of the obturation plug determined. Measurement displays of such a kind are appropriate preferably when the applicator is intended for use on a plurality of occasions.

In a further preferred arrangement of the applicator, the latter has a ram guide means which towards the proximal end is curved. This curvature facilitates introduction of the ram guide means into the root canal of a tooth, especially as, by virtue of the curvature, the applicator can be held in the direction of the oral cavity whilst the ram guide means can, by means of the curvature, be guided into the tooth root canal.

In a further preferred arrangement, the ram guide means is made of a flexible material. The curvature can accordingly be flexibly matched to the particular root canal to be filled. In especially preferred manner, the ram guide means made of a flexible material is, towards the proximal end, curved. This curvature facilitates introduction of the ram guide means into the root canal, whereas the flexibility of the material of the ram guide means makes it possible for the ram guide means to be advantageously guided into the root canal. By guiding the ram guide means into the root canal to a desired depth before an obturation mass or an obturation pin is introduced through it into the root canal, it can be ensured that the obturation mass or obturation pin is introduced into the root canal at the desired depth and/or in the desired position.

In a further preferred embodiment of the invention, the applicator has a variable stop, by means of which the depth of penetration of the obturation plug in the root canal can be variably pre-set. This function of the applicator makes it possible for overpressure, injuries and excessively deep penetration into the root canal to be avoided in the region of the apical foramen. In addition it prevents an obturation plug that has been pushed too far into the apical foramen from causing a lasting unpleasant pressure sensation and/or from leading to complications in the apical region.

In a further embodiment of the invention, the applicator has a scale arrangement, visible from the outside, which is in operative connection with the pushing mechanism and which indicates the current depth of penetration of the obturation plug in the root canal. This scale arrangement can have fine divisions down to a quarter of a millimetre in order to deposit the obturation plug exactly, with a high degree of accuracy.

In conclusion it is to be noted that the obturation device according to the invention is reliable and simple to use as well as saving time. It ensures very good plugging and sealing of the apical foramen of a root canal in a tooth.

The invention will now be explained in greater detail with reference to the accompanying Figures.

FIG. 1 shows, in diagrammatic form, a cross-section through an applicator of an obturation device according to a first embodiment of the invention;

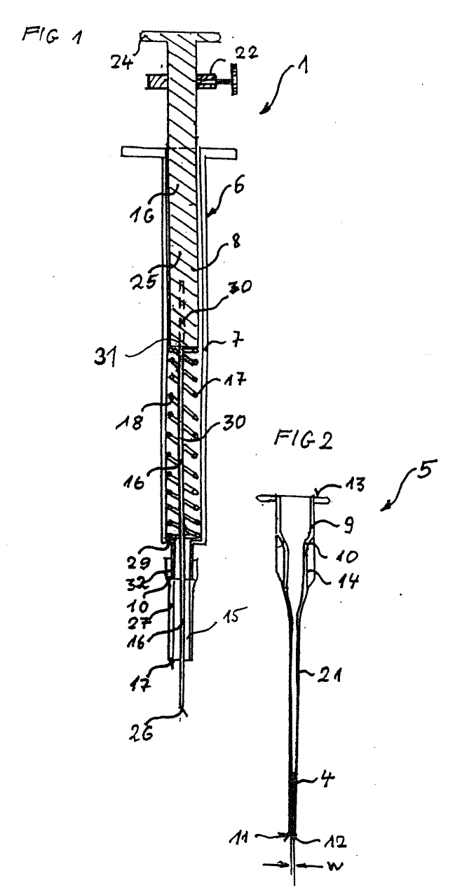

FIG. 2 shows, in diagrammatic form, a cross-section through a carrier of the obturation device according to FIG. 1;

FIG. 3 shows, in diagrammatic form, a side perspective view of an applicator of an obturation device according to a second embodiment of the invention;

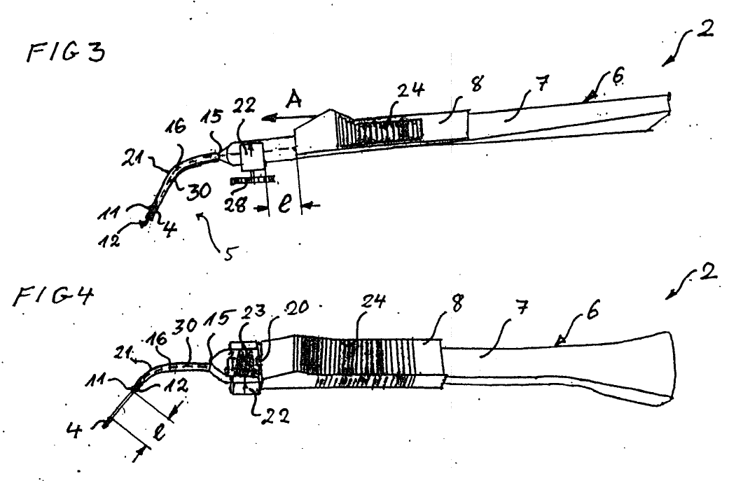

FIG. 4 shows, in diagrammatic form, a top perspective view of the applicator of the obturation device according to FIG. 3;

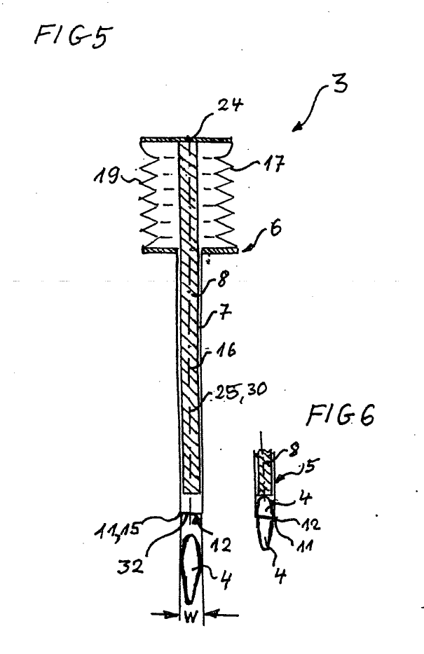

FIG. 5 shows, in diagrammatic form, a cross-section through a disposable obturation device of a third embodiment of the invention;

FIG. 6 shows, in diagrammatic form, a cross-section through a nozzle of the disposable obturation device according to FIG. 5.

FIG. 1 shows, in diagrammatic form, a cross-section through an applicator 6 of an obturation device 1 according to a first embodiment of the invention.

The applicator 6 has an elongate, tubular housing 7, in which there is arranged a pushing mechanism 8. The pushing mechanism 8 is actuated from the distal end by means of the slider 24, to which there is attached a slidingly displaceable core 25, which is movable in the upper region of the housing 7 and which has, outside the housing 7, a stop 22 which is adjustable so that different lengths of displacement are possible. The pushing mechanism 8 has, proximal to the rod-shaped core 25, a resilient restoring element 17 in the form of a helical spring 18.

In the housing 7, the helical spring 18 abuts a housing projection 29, which is arranged at the proximal end of the applicator 6 and extends as far as the proximal end of the slidingly displaceable core 25. In the centre of the helical spring 18 there is arranged a wire-like extension 30, which is fixed in the proximal end 31 of the slidingly displaceable core 25 and projects out from the proximal end 15 of the applicator 6. In this embodiment of the invention, the slidingly displaceable core with the extension forms a ram 16.

When the slider 24 is actuated, the helical spring 18 is stressed until the proximal end 26 of the ram 16 has pushed an obturation plug along a root canal and into the apical foramen for the purpose of blocking. The proximal end 32 of the housing 7 has a cone 10, which is formed by a hose-like connection piece 27 on the proximal end 32 of the housing 7. A carrier can be push-mounted on the hose-like connection piece 27.

FIG. 2 shows, in diagrammatic form, a cross-section through a carrier 5 of the obturation device 1 according to FIG. 1. At its distal end 13, the carrier 5 has a cone 10, which is matched to the cone 10 of the applicator 6 shown in FIG. 1. The carrier 5 can, with its connection projection 14 and the push-in connection 9, be pushed onto the proximal end 15 of the applicator 6 shown in FIG. 1. After the cone 10, the push-in connection projection 14 undergoes a transition into a ram guide means 21, which guides the ram 16 (shown in FIG. 1) of the applicator 6 in the direction of an obturation plug material in the region of the nozzle 12.

The obturation plug 4 in this embodiment of the invention is arranged inside the carrier 5, at the proximal end 11 of the carrier 5, the contour of the obturation plug 4 being matched to the clear width w of the nozzle 12 of the carrier 5. After push-in connection of the distal end 13 of the carrier 5 to the proximal end 15 of the applicator 6, the obturation plug 4 of gutta-percha material is pressed out of the nozzle 12 towards the apical foramen of the root canal.

In the process, the helical spring 18 (shown in FIG. 1) in the applicator 6 is stressed and, after completion of sealing of the apical foramen of the root canal, the helical spring 18 in the applicator 6 acts as a restoring element 17 and presses the pushing mechanism 8 back into its starting position. Once it has been positioned in the apical foramen, the obturation plug 4 is not loosened or displaced as a result of the springing back of the pushing mechanism 8, so that, by means of this obturation device 1, positioning of a sealing plug in the apical foramen of the root canal can be carried out successfully.

FIG. 3 shows, in diagrammatic form, a side perspective view of an obturation device with applicator 6 and carrier 5 of a second embodiment of the invention. Components having the same functions as in the preceding Figures are denoted by the same reference numerals and are not separately explained. A feature of this example of an embodiment is that the ram guide means 21 of the carrier 5 is curved at the proximal end of the applicator 6. This makes it possible for the applicator 6 to be held in a relatively horizontal orientation in the oral cavity and yet for the carrier 5 to penetrate inside the root canals of the teeth. The broken line indicates the extension 30 of the slidingly displaceable core of the ram, which is in operative connection with the pushing mechanism 8.

The pushing mechanism 8 has a slider 24, which can be actuated by hand. In this embodiment of the invention, the slider 24 slides on the housing 7 in the direction of arrow A and moves the ram 16 in the interior of the housing 7. A resilient restoring element (not shown in this drawing) in the interior of the housing ensures that the slider 24 and the ram 16 spring back into the home position shown here.

This applicator 6 too is provided with a variable stop 22, which with the aid of a fixing screw 28 can be set at or moved into any desired position, in order to fix a predetermined depth of penetration of the ram 16 into the root canal.

FIG. 4 shows, in diagrammatic form, a top perspective view of the applicator 6 and carrier 5 of the obturation device 2 according to FIG. 3. In this top view, the mode of operation of the variable stop 22 can be seen as the slider has now been pushed forward as far as the stop 22, and the ram 16 has been pushed out of the ram guide means 21 by the same length l. In addition, the applicator 6 is provided with a scale arrangement 23 having a measurement display 20, by means of which that length l, which corresponds to the depth of penetration of the ram 16 into the root canal, can be precisely measured and adjusted.

FIG. 5 shows, in diagrammatic form, a cross-section through a disposable obturation device 3 for use once, in accordance with a third embodiment of the invention. In this embodiment of the invention, the housing 7 simultaneously forms the carrier 5 for the obturation plug 4 at the proximal end of the housing 7. The ram 16 is guided inside the tubular housing 7 and simultaneously forms the slidingly displaceable core 25. The tubular housing 7 can also be a flexible hose, which for example has a pre-formed curve, in which a flexible wire forms the ram 16 or in which a plastics stem is arranged and forms a flexible ram 16.

The proximal end 32 of the housing 7 is also simultaneously the nozzle 12 of the obturation device 3, the clear width w of which nozzle is matched to the contour of a gutta-percha obturation plug 4. In this embodiment of the invention, the obturation plug 4 is in the shape of a double cone, which at its proximal end forms a point and the distal end of which is matched to the clear width w of the nozzle 12. The distal end 33 of the applicator 6 has the slider 24, which is connected to the housing 7 by way of the bellows 19. The bellows 19 simultaneously forms a resilient restoring element 17 so that, after pressing the obturation plug 4 into the apical foramen of the root canal, the ram 16 springs back into the starting position shown here.

FIG. 6 shows, in diagrammatic form, a cross-section through a nozzle 12 of the disposable obturation device 3 according to FIG. 5. In FIG. 6, the obturation plug 4 has been guided into the nozzle 12, which simultaneously forms the proximal end 11 of the carrier 5 and also the proximal end 15 of the applicator 6 in order to guide it to the apical foramen of the tooth by way of the root canal and to seal off that foramen with the gutta-percha obturation plug 4.

### LIST OF REFERENCE SYMBOLS

1 Obturation device (first embodiment)
2 Obturation device (second embodiment)
3 Disposable obturation device (third embodiment)
4 Obturation plug
5 Carrier
6 Applicator
7 Housing
8 Pushing mechanism
9 Push-in connection
10 Cone
11 Proximal end of the carrier
12 Nozzle of the carrier
13 Distal end of the carrier
14 Push-in connection projection
15 Proximal end of the applicator
16 Ram
17 Restoring element
18 Helical spring
19 Bellows
20 Measurement display
21 Ram guide means
22 Variable stop
23 Scale arrangement
24 Slider
25 Slidingly displaceable core
26 Proximal end of the ram
27 Hose-like end piece
28 Fixing screw
29 Housing projection
30 Extension
31 Proximal end of the core
32 Proximal end of the housing
33 Distal end of the applicator
l Length
w Width

1. Obturation device for blocking an apical foramen of a root canal of a tooth by means of an obturation plugging mass, the obturation device (1) having a carrier (5) with an obturation plugging mass and having an applicator (6), by means of which the obturation plugging mass is applied in the apical foramen, the applicator (6) having a housing (7) with a pushing mechanism (8), which mechanism is arranged to be brought into engagement with the carrier (5) and pushes the obturation plugging mass from the carrier (5) into the apical foramen.

2. Obturation device according to claim 1,
characterised in that the obturation device (1) has a push-in, screwed and/or adhesive connection between the carrier (5) and the applicator (6).

3. Obturation device according to claim 2,
characterised in that the push-in connection (9) has a cone (10).

4. Obturation device according to claim 1, characterised in that the carrier (5) has, at a proximal end (11), a nozzle (12) and, at a distal end (13), a connection projection (14), which can be push-mounted or screw mounted on a proximal end (15) of the applicator (6).

5. Obturation device according to claim 4,
characterised in that the clear width (w) of the nozzle (12) is matched to the external dimensions of the obturation plug (4) to be formed.

6. Obturation device according to claim 1, characterised in that the obturation plugging mass (4) is arranged in the carrier (5).

7. Obturation device according to claim 1, characterised in that the obturation plugging mass comprises gutta-percha points or consists of gutta-percha points.

8. Obturation device according to claim 1, characterised in that the obturation plugging mass is present in granulate or paste form.

9. Obturation device according to claim 1, characterised in that the obturation plugging mass comprises a prefabricated obturation plug (4).

10. Obturation device according to claim 9,
characterised in that the obturation plug (4) has a length l in the range from 0.1 mm to 10 mm, preferably in the range from 1 mm to 5 mm.

11. Obturation device according to claim 9, characterised in that the obturation plug (4) has a cylindrical contour.

12. Obturation device according to claim 9, characterised in that the obturation plug (4) comprises a conical plug having a slope, as desired, from 4% to 10%.

13. Obturation device according to claim 9, characterised in that in its cross-section the obturation plug (4) corresponds to an ISO standard.

14. Obturation device according to claim 9, characterised in that the obturation plug (4) has a step-shaped external contour.

15. Obturation device according to claim 1, characterised in that the applicator (6) has an elongate, tubular housing (7).

16. Obturation device according to claim 1, characterised in that the pushing mechanism has a ram (16) and a restoring element (17).

17. Obturation device according to claim 1, characterised in that the pushing mechanism (8) has a helical spring (18).

18. Obturation device according to claim 1, characterised in that the applicator has a bellows.

19. Obturation device according to claim 1, characterised in that the pushing mechanism (8) of the applicator (6) is in operative connection with a measurement display (20), by means of which the depth of the root canal can be measured and/or the position of the obturation plug (4) determined.

20. Obturation device according to claim 1, characterised in that the carrier (6) has a ram guide means (21) which towards the proximal end (15) is curved.

21. Obturation device according to claim 1, characterised in that the applicator (6) has a variable stop (22), by means of which the depth of penetration of the obturation plug (4) in the root canal is variably settable.

22. Obturation device according to claim 1, characterised in that the applicator (6) has a scale arrangement (23), visible from the outside, which is in operative connection with the pushing mechanism (8) and which indicates the current depth of penetration of the obturation plug (4) in the root canal.

23. Obturation device according to claim 1, characterised in that the pushing mechanism (8) of the applicator (6) has a slider (24), which is in operative connection with a slidingly displaceable core (25) inside the applicator (6) and which acts on the obturation plug (4).

24. Obturation device according to claim 1, characterised in that the obturation device (3) is intended for use once.

25. Obturation device according to claim 1, characterised in that the carrier (5) and/or the applicator (6) is/are intended for use once.
